(19) United States
(12) Patent Application Publication
(10) Pub. No.: US 2015/0050570 A1
(43) Pub. Date: Feb. 19, 2015

(54) PRODUCTION OF VANADIUM ELECTROLYTE FOR A VANADIUM FLOW CELL

(71) Applicant: Imergy Power Systems Inc., Fremont, CA (US)

(72) Inventors: Majid Keshavarz, Pleasanton, CA (US); Ge Zu, San Jose, CA (US)

(21) Appl. No.: 14/526,435

(22) Filed: Oct. 28, 2014

Related U.S. Application Data
(63) Continuation-in-part of application No. 13/651,230, filed on Oct. 12, 2012.
(60) Provisional application No. 61/547,643, filed on Oct. 14, 2011.

(51) Int. Cl. H01M 8/18; H01M 8/20

(52) U.S. Cl. CPC H01M 8/188; H01M 8/20
USPC 429/409; 429/500

(57) ABSTRACT

A Vanadium chemistry flow cell battery system is described. Methods of forming the electrolyte, a formulation for the electrolyte, and a flow system utilizing the electrolyte are disclosed. In some embodiments, the vanadium electrolyte is sulfate-free.

### REFERENCE TO RELATED APPLICATIONS

The present applications is a continuation-in-part of U.S. application Ser. No. 13/651,230, which claims priority to U.S. Provisional Application No. 61/547,643, entitled “Vanadium Flow Cell”, filed on Oct. 14, 2011, the contents of each are herein incorporated by reference in its entirety.

### BACKGROUND

1. Field of the Invention

Embodiments disclosed herein generally relate to Vanadium based flow cell batteries and in particular to the electrolyte used in the Vanadium based flow cell.

2. Description of the Relevant Art

There is an increasing demand for novel and innovative electric power storage systems. Redox flow cell batteries have become an attractive means for such energy storage systems. In certain applications, a redox flow cell battery may include one or more redox flow cells. Each of the redox flow cells may include positive and negative electrodes disposed in separate half-cell compartments. The two half-cells may be separated by a porous or ion-selective membrane, through which ions are transferred during a redox reaction. Electrolytes (anolyte and catholyte) are flowed through the half-cells as the redox reaction occurs, often with an external pumping system. In this manner, the membrane in a redox flow cell battery operates in an aqueous electrolyte environment.

In order to provide a consistent supply of energy, it is important that many of the components of the redox flow cell battery system are performing properly. Redox flow cell battery performance, for example, may change based on parameters such as the state of charge, temperature, electrolyte level, concentration of electrolyte and fault conditions such as leaks, pump problems, and power supply failure for powering electronics.

Vanadium based flow cell systems have been proposed for some time. However, there have been many challenges in developing a Vanadium based system that would be economically feasible. These challenges include, for example, the high cost of the Vanadium electrolyte, the high cost of appropriate membranes, the low energy density of dilute electrolyte, thermal management, impurity levels in the Vanadium, inconsistent performance, stack leakage, membrane performance such as fouling, electrode performance such as delamination and oxidation, rebalance cell technologies, and system monitoring and operation.

One group has investigated vanadium/vanadium electrolytes in H₂SO₄. In that effort, V₂O₅+V₂O₃+H₂SO₄ yields VOSO₄. An electrochemical reduction of V₂O₅+H₂SO₄ can also yield VOSO₄. However, preparation of the electrolyte has proved difficult and impractical. Another group has tried a mixture of H₂SO₄ and HCl by dissolving VOSO₄ in HCl. However, again the electrolyte has proved to be expensive and impractical.

Therefore, there is a need for better redox flow cell battery systems.

### SUMMARY

Embodiments of the present invention provide a vanadium based flow cell system. A method for providing an electrolyte solution according to some embodiments includes forming a solution of a vanadium oxide and hydrochloric acid; adjusting ionic species in the solution to form a mixture of V(III) and V(IV); and adjusting the acidity of the solution to form the electrolyte solution.

In some embodiments, a sulfate-free vanadium electrolyte is formed by mixing V₂O₃ and V₂O₅ with hydrochloric acid in a reactor; allowing a reaction to complete to form a solution with V(III) and V(IV) in hydrochloric acid; and filtering the solution to provide the electrolyte

These and other embodiments of the invention are further described below with respect to the following figures.

### BRIEF DESCRIPTION OF THE DRAWINGS

FIG. 1 shows a vanadium based redox flow cell according to some embodiments of the present invention in a system.

FIG. 2 illustrates a method of providing a vanadium electrolyte.

FIG. 3A illustrates production of a balanced electrolyte according to some embodiments of the present invention.

FIG. 3B illustrates production of electrolytes according to some embodiments of the present invention.

FIG. 4 illustrates another method of production of electrolytes according to some embodiments of the present invention.

FIGS. 5A and 5B illustrate processes for production of electrolytes according to some embodiments of the present invention.

FIGS. 5C and 5D further illustrate examples of production of sulfate-free vanadium electrolyte according to some embodiments of the present invention.

FIGS. 6A and 6B illustrate viscosity of some example compositions of electrolyte according to some embodiments of the present invention at different operating temperatures.

FIG. 7 illustrates viscosity of sulfate-free of electrolyte according to some embodiments of the present invention with varying vanadium concentrations at different operating temperatures.

FIGS. 8A, 8B and 8C illustrate the electrochemical properties of a sulfate-free electrolyte according to some embodiments of the present invention during operation in a flow-cell battery.

FIGS. 9 demonstrate successful application of sulfate-free electrolyte in high concentration (energy density) and high ambient temperature.

Where possible in the figures, elements having the same function have the same designation.

### DETAILED DESCRIPTION

It is to be understood that the present invention is not limited to particular devices or methods, which may, of course, vary. It is also to be understood that the terminology used herein is for the purpose of describing particular embodiments only, and is not intended to be limiting.

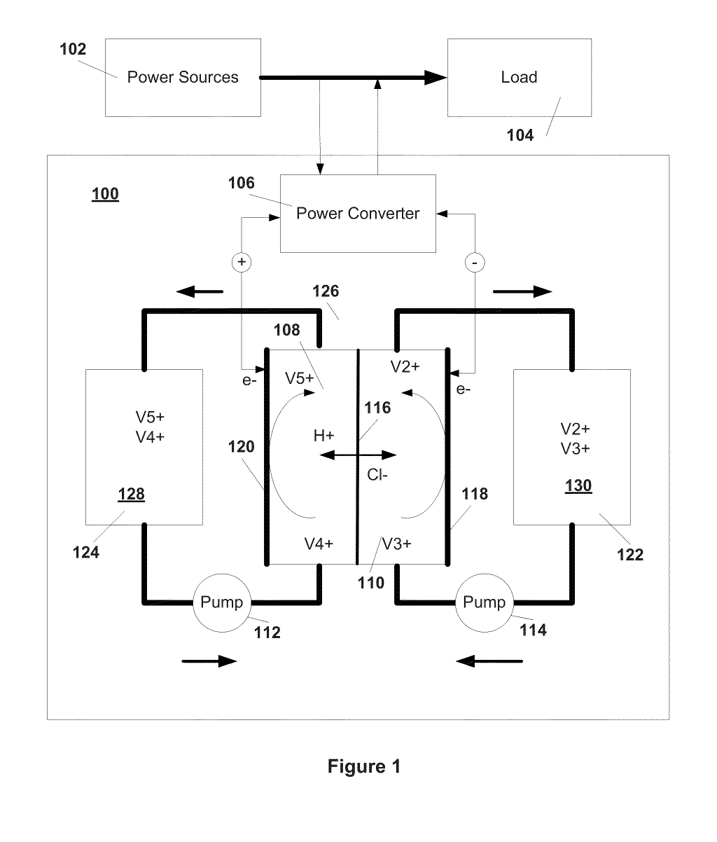

FIG. 1 illustrates a vanadium based flow system 100 according to some embodiments of the present invention. As shown in FIG. 1, system 100 is coupled between power sources 102 and a load 104. Power sources 102 can represent any source of power, including an AC power grid, renewable power generators (solar, wind, hydro, etc.), fuel generators, or any other source of power. Load 104 can represent any user of power, for example a power grid, building, or any other load devices.

As shown in FIG. 1, redox flow cell system 100 includes redox flow cell stack 126. Flow cell stack 126 illustrates a single cell, which includes two half-cells 108 and 110 separated by a membrane 116, but in most embodiments is a collection of multiple individual cells. An electrolyte 128 is flowed through half-cell 108 and an electrolyte 130 is flowed through half-cell 110. Half-cells 108 and 110 include electrodes 120 and 118, respectively, in contact with electrolytes 128 and 130, respectively, such that redox reactions occur at the surface of the electrodes 120 or 118. In some embodiments, multiple redox flow cells 126 may be electrically coupled (e.g., stacked) either in series to achieve higher voltage or in parallel in order to achieve higher current. The stacked cells 126 are collectively referred to as a battery stack and flow cell battery can refer to a single cell or battery stack. As shown in FIG. 1, electrodes 120 and 118 are coupled across power converter 106, through which electrolytes 128 and 130 are either charged or discharged.

When filled with electrolyte, half-cell 110 of redox flow cell 100 contains anolyte 130 and the other half-cell 108 contains catholyte 128, the anolyte and catholyte being collectively referred to as electrolytes. Reactant electrolytes may be stored in separate reservoirs 124 and 122, respectively, and dispensed into half-cells 108 and 110 via conduits coupled to cell inlet/outlet (I/O) ports. In some embodiments, an external pumping system is used to transport the electrolytes to and from the redox flow cell.

At least one electrode 120 and 118 in each half-cell 108 and 110 provides a surface on which the redox reaction takes place and from which charge is transferred. Redox flow cell system 100 operates by changing the oxidation state of its constituents during charging or discharging. The two half-cells 108 and 110 are connected in series by the conductive electrolytes, one for anodic reaction and the other for cathodic reaction. In operation (e.g., during charge or discharge), electrolytes 126 and 124 are flowed through half-cells 108 and 110.

Electrolyte is flowed through half-cell 108 from holding tank 124, the positive electrolyte, by a pump 112. Electrolyte is flowed through half-cell 110 from holding tank 122, the negative electrolyte, through pump 114. Holding tank 124, during operation, holds an electrolyte formed from V⁵⁺ and V⁴⁺ species while holding tank 122 holds an electrolyte formed from V²⁺ and V³⁺ species. As discussed below, starting from a balanced electrolyte (a 1:1 ratio of V³⁺ and V⁴⁺) an initial charging results in the V³⁺ in tank 122 being converted to V⁴⁺ and the V⁴⁺ in tank 122 being converted to V³⁺. After the initial charge, then charging of flow cell 100 results in conversion of V⁴⁺ to V⁵⁺ in the positive electrolyte stored in tank 124 and conversion of V³⁺ to V²⁺ in the negative electrolyte stored in tank 122. Discharge of flow cell 100 results in conversion of V⁵⁺ to V⁴⁺ in tank 124 and V²⁺ to V³⁺ in tank 122.

Positive ions or negative ions pass through permeable membrane 116, which separates the two half-cells 108 and 110, as the redox flow cell 100 charges or discharges. Reactant electrolytes are flowed through half-cells 108 and 110, as necessary, in a controlled manner to supply electrical power or be charged through power converter 106. Suitable membrane materials for membrane 106 include, but are not limited to, materials that absorb moisture and expand when placed in an aqueous environment. In some embodiments, membrane 106 may comprise sheets of woven or non-woven plastic with active ion exchange materials such as resins or functionalities embedded either in a heterogeneous (such as co-extrusion) or homogeneous (such as radiation grafting) way. In some embodiments, membrane 106 may be a porous membrane having high voltaic efficiency Ev and high coulombic efficiency and may be designed to limit mass transfer through the membrane to a minimum while still facilitating ionic transfer. In some embodiments, membrane 106 may be made from a polyolefin material or fluorinated polymers and may have a specified thickness and pore diameter. A manufacturer having the capability to manufacture these membranes, and other membranes consistent with embodiments disclosed, is Daramic Microporous Products, L.P., N. Community House Rd., Suite 35, Charlotte, N.C. 28277. In certain embodiments, membrane 106 may be a nonselective microporous plastic separator also manufactured by Daramic Microporous Products L.P. A flow cell formed from such a membrane is disclosed in U.S. Published Patent App. No. 2010/0003586, filed on Jul. 1, 2008, which is incorporated herein by reference.

In general, membrane 116 can be any material that forms a barrier between fluids, for example between electrochemical half-cells 108 and 110 (e.g., an anode compartment and a cathode compartment). Exemplary membranes may be selectively permeable, and may include ion-selective membranes. Exemplary membranes may include one or more layers, wherein each layer exhibits a selective permeability for certain species (e.g., ions), and/or effects the passage of certain species.

As shown in FIG. 1, the electrolytic reactions for the Vanadium chemistry involve V³⁺+e⁻→V²⁺ in half-cell 110 and VO₂⁺ (V⁵⁺)+2H⁺+e⁻→VO²⁺(V⁴⁺)+H₂O. The open circuit voltage of each cell in stack 126 is then 1.25V, (−0.25 V from half-cell 110 and 1.00V from half-cell 108). As shown in FIG. 1, ions H⁺ and Cl⁻ (or sulfate) may traverse membrane 116 during the reaction.

In some embodiments, multiple redox flow cells may be stacked to form a redox flow cell battery system. Construction of a flow cell stack battery system is described in U.S. patent application Ser. No. 12/577,134, entitled “Common Module Stack Component Design” filed on Oct. 9, 2009, which is incorporated herein by reference.

Further descriptions of details of redox flow cell battery systems can be found in the following U.S. Patent Applications, all of which are incorporated herein by reference: U.S. patent application Ser. No. 11/674,101 (now U.S. Pat. No. 7,855,005), entitled “Apparatus and Methods of Determination of State of Charge in a Redox Flow Battery”, filed on Feb. 12, 2007; U.S. application Ser. No. 12/074,110 (now U.S. Pat. No. 8,587,150), entitled “Battery Charger”, filed on Feb. 28, 2008; U.S. patent application Ser. No. 12/217,059 (now U.S. Pat. No. 7,927,731), entitled “Redox Flow Cell,” filed on Jul. 1, 2008; U.S. patent application Ser. No. 12/576,235 (now U.S. Pat. No. 8,236,463), entitled “Magnetic Current Collector” filed on Oct. 8, 2009; U.S. patent application Ser. No. 12/576,242 (now U.S. Pat. No. 8,264,202), entitled “Method and Apparatus for Determining State of Charge of a Battery” filed on Oct. 9, 2009; U.S. patent application Ser. No. 12/577,127 (now U.S. Pat. No. 7,919,204), entitled “Thermal Control of a Flow Cell Battery” filed on Oct. 9, 2009; U.S. patent application Ser. No. 12/577,131, entitled “Methods for Bonding Porous Flexible Membranes Using Solvent” filed on Oct. 9, 2009; U.S. patent application Ser. No. 12/577,134, entitled “Common Module Stack Component Design” filed on Oct. 9, 2009; U.S. patent application Ser. No. 12/577,147 (now U.S. Pat. No. 8,230,736), entitled “Level Sensor for Conductive Liquids” filed on Oct. 9, 2009; U.S. patent application Ser. No. 12/790,793 (now U.S. Pat. No. 8,587,255), entitled “Control System for a Flow Cell Battery”, filed May 28, 2010; U.S. patent application Ser. No. 12/790,794, entitled “Hydrogen Chlorine Level Detector”, filed May 28, 2010; U.S. patent application Ser. No. 12/790,749 (now U.S. Pat. No. 8,349,477), entitled “Optical Leak Detection Sensor”, filed May 28, 2010; U.S. patent application Ser. No. 12/790,783 (now U.S. Pat. No. 8,723,489) entitled “Buck-Boost Control Circuit”, filed May 28, 2010; U.S. patent application Ser. No. 12/790,753 (now U.S. Pat. No. 8,877,365), entitled “Flow Cell Rebalancing”, filed May 28, 2010; U.S. patent application Ser. No. 13/350,424 entitled “Flow Cell Stack”, filed on Jan. 13, 2012; U.S. patent application Ser. No. 13/084,381 entitled “Communications System”, filed on May 11, 2011; U.S. patent application Ser. No. 12/844,059 entitled “System Dongle” filed on Aug. 12, 2010; U.S. patent application Ser. No. 13/350,688 entitled “Flow Battery Start-Up and Recovery Management”, filed on Jan. 13, 2012; U.S. patent application Ser. No. 13/350,628 entitled “Field Response System”, filed on Jan. 13, 2012; U.S. patent application Ser. No. 13/651,230 entitled “Vanadium Flow Cell”, filed on Oct. 12, 2012; U.S. patent application Ser. No. 13/842,446 entitled “Vanadium Flow Cell”, filed on Mar. 15, 2013; U.S. patent application Ser. No. 13/843,085 entitled “Electrochemical Balance in a Vanadium Flow Battery”, filed on Mar. 15, 2013; and U.S. patent application Ser. No. 14/484,929 entitled “Flow Cell Stack with Single Plate Cells”, filed on Sep. 12, 2014.

Embodiments of the invention disclosed herein attempt to solve many of the challenges involved with utilizing a Vanadium chemistry in a redox flow cell. As such, this disclosure is separated into three sections: I. Preparation of the Electrolyte; II. Formulation of the Electrolyte; and III. The flow cell battery system.

### I. Electrolyte Preparation

Vanadium electrolyte can be very expensive to prepare. In previous efforts, VOSO₄ is utilized as a starting material for preparation of the electrolyte. However, VOSO₄ is very expensive to procure and VOCl₂ is not commercially available. The correct oxidation state of vanadium, as starting material, for vanadium redox flow battery is V⁴⁺ for positive side and V³⁺ for negative side or a 1:1 mixture of V⁴⁺ and V³⁺ for both sides, which is often referred to as V^{3.5+} or “balanced electrolyte.” In accordance with some aspects of the present invention, the electrolyte material can be formed from a V⁵⁺ compound such as V₂O₅. V₂O₅ is much less expensive to procure than is VOSO₄, and is much more readily available. The electrolyte is then formed of lower oxidation states of the V⁵⁺ of V₂O₅. In some embodiments, the electrolyte material can be formed from V³⁺ of V₂O₃ or other vanadium species may be used starting with VₓO_{y}.

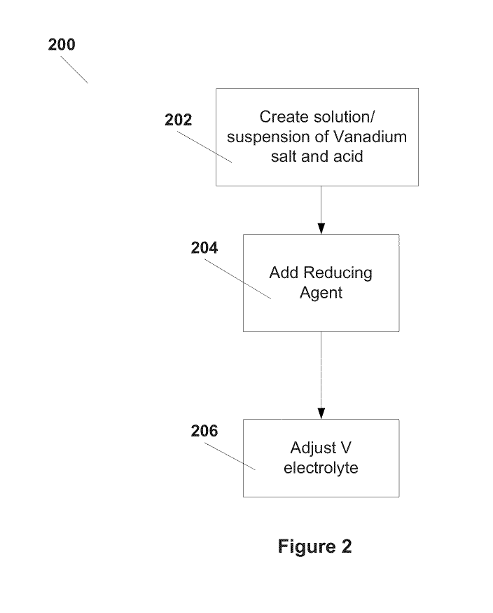

In accordance with some embodiments of the present invention, a vanadium electrolyte is formed from a source of V⁵⁺ by adding a reducing agent and an acid. A method of producing a vanadium based electrolyte is illustrated in procedure 200 shown in FIG. 2. As shown in FIG. 2, step 202 includes creating a solution and/or suspension of Vanadium and acid. In general, the solution or suspension includes V⁵⁺. V⁵⁺ can be obtained, for example, with the compounds V₂O₅, MVO₃, or M₃VO₄, where M can be NH₄⁺, Na⁺, K⁺, or some other cations, although some of these compounds may leave impurities and undesired ions in the electrolyte. The acid can be H₂SO₄, HCl, H₃PO₄, CH₃SO₃H, or a mixture of these acids. In some embodiments, the acid is a mixture of H₂SO₄ and HCl. In some cases, only HCl is utilized. Previously, H₂SO₄ has been utilized as the acid in the electrolyte. However, a combination of HCl and H₂SO₄ or all HCl can be utilized in some embodiments.

In step 204, a reducing agent is added to the Vanadium containing acid solution formed in step 202. The general reaction is given by

V⁵⁺+Reducing Agent+Acid→V⁽⁵⁻ⁿ⁾⁺,
where n=1, 2, or 3. The reducing agent can be an organic reducing agent or an inorganic reducing agent. Organic reducing agents include one carbon reagent, two carbon reagents, three carbon reagents, and four or higher carbon reagents.

One carbon reducing agents include methanol, formaldehyde, formic acid, and nitrogen containing functional groups like acetamide or sulfur containing functional groups like methyl mercaptane or phosphorous functional groups. For example, one such reaction, for example, starts with methanol as follows:

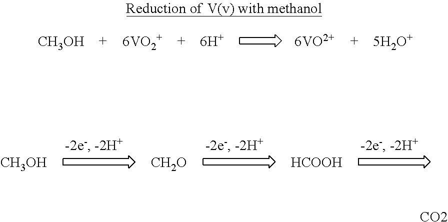

In this reaction, methanol to formaldehyde to formic acid provides the reduction of the V⁵⁺, resulting in the emission of CO₂. The electrons go to reducing the vanadium charge state. The reaction can also begin with formaldehyde or formic acid or any mixture of them.

Two carbon reducing agents include ethanol, acetaldehyde, acetic acid, ethylene glycol, glycol aldehyde, oxaldehyde, glycolic acid, glyoxalic acid, oxalic acid, nitrogen containing functional groups such as 2-aminoethanol, sulfur containing functional groups like ethylene dithiol. One such reaction starts with ethylene glycol and ends again with CO₂:

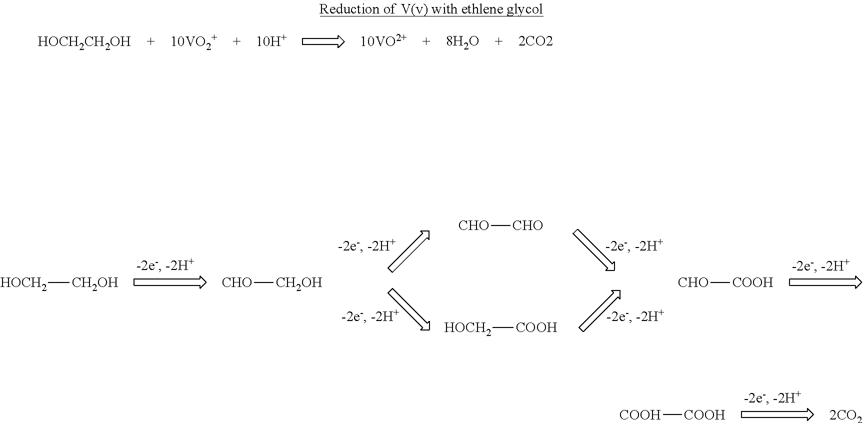

Ethylene glycol C₂H₄(OH)₂ is very useful as a reducing agent since it provide 10 electrons and final product is gaseous carbon dioxide.

Three carbon reducing agents can also be used. Such reducing agents include 1-propanol, 2-proponal, 1,2-propanediol, 1,3-propanedial, glycerol, propanal, acetone, propionic acid and any combination of hydroxyl, carbonyl, carboxylic acid, nitrogen containing functional groups, sulfur containing functional groups, and phosphourous functional groups. Of these, glycerol is a great source of electrons that work like ethylene glycol. The only by-product is gaseous carbon dioxide and glycerol provides 14 electrons to the reduction reaction. The chemical reduction utilizing glycerol can be described as:

HOCH₂—HCOH—H₂COH+14VO₂+14H⁺ [symbol] 14VO²⁺+11H₂O+3CO₂.

Four or more carbon organic molecules with any combination of hydroxyl, carbonyl, carboxylic acid, nitrogen containing functional groups, sulfur containing functional groups, or phosphorous functional groups can be utilized. For example, sugar (e.g. glucose or other sugar) can be utilized.

The result in each of the organic reducing agents is to reduce the V⁵⁺ to V⁽⁵⁻ⁿ⁾⁺, n=1, 2, 3, (mainly n=1) without addition of high concentrations of impurity compounds in the resulting electrolyte. Many of these reducing agents (e.g., methanol glycerol, sugar, ethylene glycol) provide a large number of electrons to the reducing reaction while producing carbon dioxide and water as byproducts.

In addition to the organic reagents described above, inorganic reducing agents can also be utilized. Inorganic reducing agents can include, for example, sulfur, and sulfur dioxide. Any sulfide, sulfite, or thiosulfate salt can also be utilized. Sulfur compounds work great, especially if sulfate salt is desired in the final formulation. However, the resulting solution may have higher concentrations of sulfuric acid at completion of the process. Sulfide salts can be utilized, resulting in the added ions appearing in the solution at the end of the process. Additionally, vanadium metal can be utilized. Vanadium metal can easily give up four electrons to form V⁴⁺.

Secondary reducing agents, which can be added in small quantities, can include any phosphorous acid, hypophophorous acid, oxalic acid and their related salts. Any nitrogen based reducing agent can be utilized. Further, metals can be included, for example Alkali metals, alkaline earth metals, and some transition metals like Zn and Fe.

The reduction process outlined in step 204 of FIG. 2 can be assisted with heating or may proceed at room temperature. Reagent is added until the vanadium ion concentration is reduced as far as desired. In step 206, the acidity of the resulting vanadium electrolyte can be adjusted by the addition of water or of additional acid.

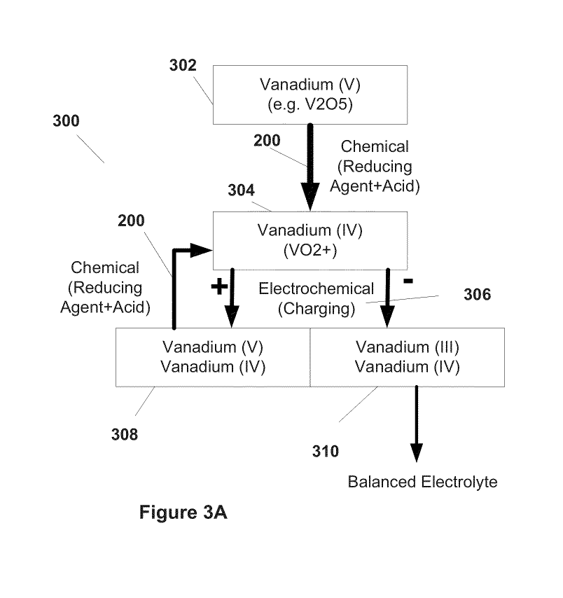

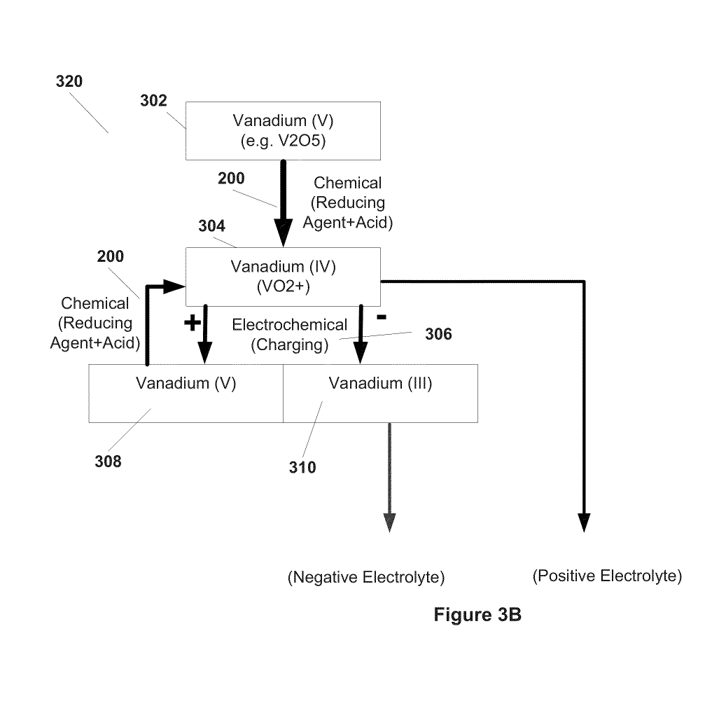

FIG. 3A illustrates a procedure 300 of producing vanadium based electrolyte according to some embodiments of the present invention. In first state 302, a starting preparation of V⁵⁺ (e.g., an acidic solution/suspension of V₂O₅) is prepared as discussed above. A chemical reducing reaction such as that illustrated in procedure 200 discussed above is performed to provide an acidic solution 304 of V⁴⁺, which is prepared from the reduction of V₂O₅ as discussed above. As discussed above, solution 304 may contain any reduction of V⁵⁺, e.g. V⁽⁵⁻ⁿ⁾⁺, however for purposes of explanation solution 304 can be an acidic solution of primarily V⁴⁺.

Solution 304 is then utilized to fill the holding tanks of an electrochemical cell. The electrochemical cell can be, for example, similar to flow cell system 100 illustrated in FIG. 1. In some embodiments, procedure 300 can utilize a flow cell 100 as illustrated in FIG. 1 that includes a single electrochemical cell. In some embodiments, a stack 126 that includes individual multiple cells can be utilized in procedure 300.

In some embodiments, the electrochemical cell can be a photochemical cell such as the rebalance cell described in U.S. patent application Ser. No. 12/790,753 entitled “Flow Cell Rebalancing”, filed May 28, 2010, which is incorporated herein by reference. Such a cell can be utilized to generate low-valence vanadium species from V⁵⁺. The rebalance cell is a redox reaction cell with two electrodes on either end and a membrane between the two electrodes that provides a negative side and a positive side. The positive side includes an optical source that assists in generating the HCl solution. On the negative side of the rebalance cell, V⁵⁺ can be reduced to V²⁺ or the reduction can be stopped at V⁴⁺ or V³⁺ oxidation states. On the positive side, HCl will be oxidized electrochemically to Cl₂ gas or, with the addition of H₂, recombined in the photochemical chamber to regenerate HCl.

In step 306, the electrochemical cell containing solution 304 is charged. Electrochemical charging can proceed to a nominal state of charge. This results in solution 308, for example in tank 124 of flow cell 100, containing V⁵⁺ and solution 310, for example in tank 122 of flow cell 100, containing V³⁺. In some embodiments, the reaction may be stopped when solution 310 achieves a balanced electrolyte of 1:1 ratio of V³⁺ and V⁴⁺. As illustrated in FIG. 3A, solution 310 can then be used as a balanced electrolyte in both the positive and negative sides of a flow cell battery such as flow cell 100 illustrated in FIG. 1. As illustrated in FIG. 3A, electrochemical charging 306 results in a solution 308 from the positive side of the electrochemical cell that includes V⁵⁺ and a solution 310 from the negative side of the electrochemical cell that includes V³⁺. Solution 308 can undergo further chemical reduction in process 200 and then be included in solution 304. As is further shown in FIG. 3B illustrates a procedure 320 for producing electrolyte according to some embodiments of the present invention. Procedure 320 is similar to procedure 300 illustrated in FIG. 3A. However, in procedure 320, electrochemical charging reaction 306 is allowed to proceed to a higher state of charge, in some cases close to 100%. In that case, solution 310 can be utilized as the negative electrolyte and solution 304 utilized as the positive electrolyte in a flow cell battery.

Regardless as to whether procedure 300 outlined in FIG. 3A or procedure 320 illustrated in FIG. 3B is utilized, the electrolyte solution on the positive side of a flow cell battery will yield V⁵⁺ on charging and the negative side of the flow cell battery will yield V²⁺ on charging. On discharge, the electrolytes release their stored energy and return to the uncharged state. Further, solution 302 can be formed utilizing any combination of acids. For example, solution 302 can be formed of HCl and be sulfur free (i.e. not include H₂SO₄), can be a mixture of HCl and H₂SO₄, or can be formed of H₂SO₄. The resulting electrolyte can, in some cases, be sulfur free (often referred to as sulfate-free).

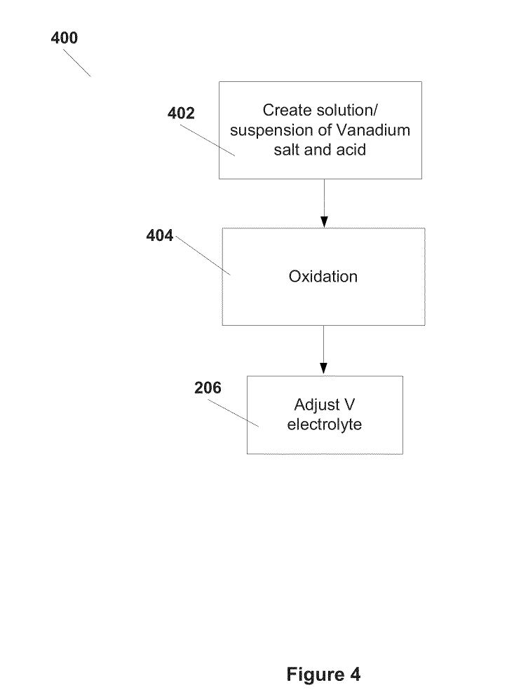

FIG. 4 illustrates another method that can be used to obtain the vanadium electrolyte. As shown in FIG. 4, method 400 in step 402 includes providing V₂O₃ in an acid that includes hydrochloric acid. In the case where a starting material of V₂O₃ is available, the resulting reaction is given by

V₂O₃+6HCl=>2VCl₃+3H₂O
with a resulting V (III) valence state. The resulting solution of VCl₃ can then be oxidized in step 404. Oxidation can occur in air or by adding oxygen to the solution, for example by bubbling oxygen through the solution. With the addition of oxygen, some of the VCl₃ can be converted to VOCl₂, resulting in the creation of V(IV), as follows:

4VCl₃+O₂+2H₂O=>4VOCl₂+4HCl.

In some embodiments, a combination of V₂O₃ and V₂O₅, both readily available starting materials, can result in the reaction

V₂O₅+3V₂O₃+20HCl=>4VCl₃+4VOCl₂+10H₂O.
As is illustrated in the above reaction, a certain mixture of V₂O₅ to V₂O₃ can result in a 50:50 concentration of V(III) and V(IV) in the resulting solution, without the need for a separate oxidation step. However, other mixtures of V₂O₃ and V₂O₅ can be used as well. As discussed above, the concentration of V(III) can be converted to V(IV) in oxidation step 404.

In general, any oxide material VxOy or combination of different can be used in the reaction with hydrochloric acid. The resulting Vanadium electrolyte can be oxidized or otherwise adjusted as discussed here to provide an end solution balanced electrolyte.

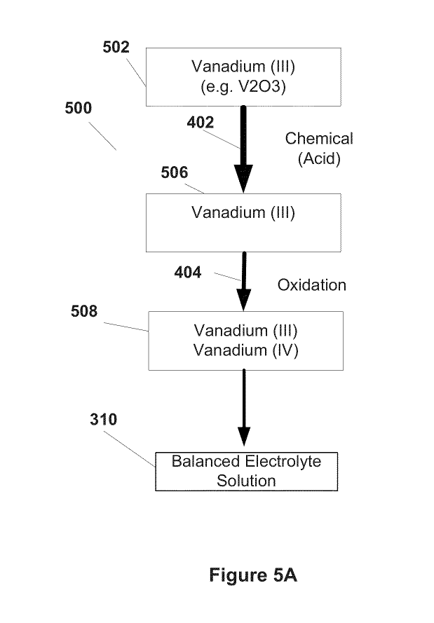

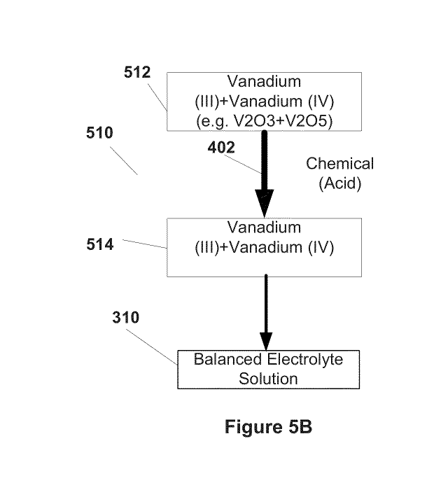

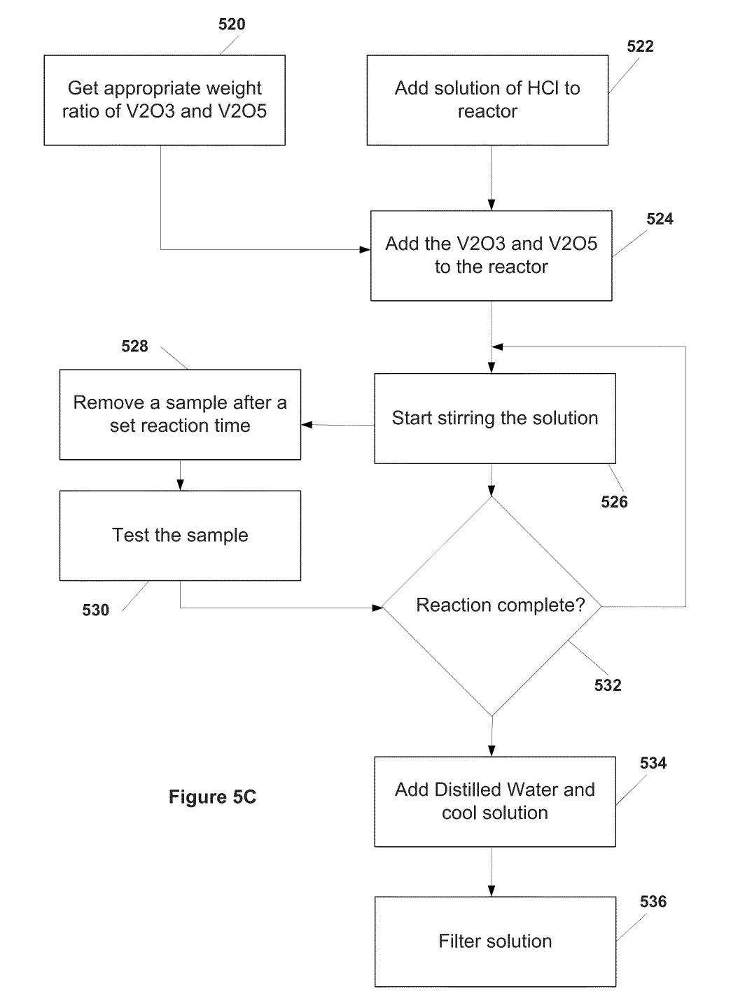

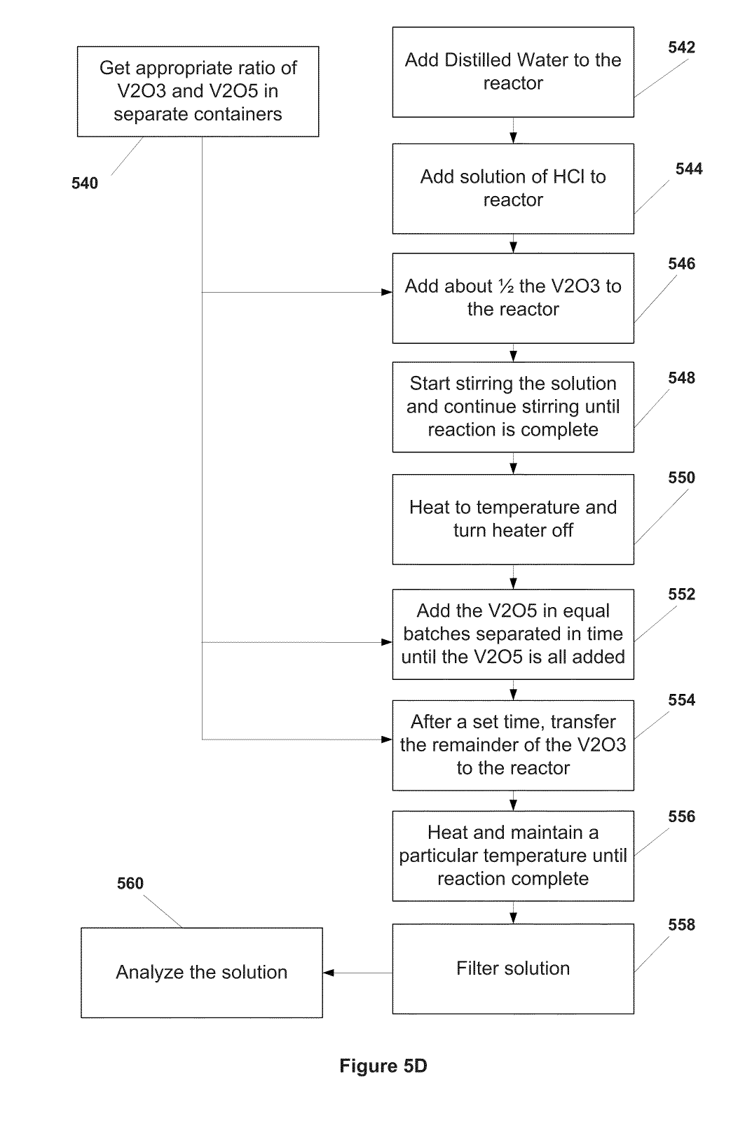

FIG. 5A illustrates an example procedure 500 for producing electrolyte according to some embodiments of the present invention. As shown in FIG. 5A, in state 502 a starting solution of V₂O₃ (V(III)) is provided. As shown in step 402, the solution includes acid with HCl that results in the reactions discussed above. Initially, with the presence of hydrochloric acid, the solution includes V(III). Oxidation step 404 can then be performed in order to convert some of the V(III) in solution to V(IV), as discussed above, resulting in a solution 304 with a mixture of V(III) and V(IV). Oxidation step 404 may be completed when a balanced ratio of V(III) and V(IV) is achieved in solution 310, which can then be used as a balanced electrolyte in both the positive and negative sides of a flow cell battery. As discussed above, balanced electrolyte solution 310 can have a 50/50 mixture of V(III) and V(IV). FIG. 5B illustrates another process for producing electrolyte without use of oxidation step 404 according to some embodiments of the invention. As shown in step 512, a solution of V₂O₃, V(III), and V₂O₅, V(V), is provided. As discussed above, in some embodiments a 2:1 to 6:1 ratio of V₂O₃ and V₂O₅ is provided in step 502. The chemical acid solution step 402 results in a solution 514 that includes both V(III) and V(IV). As discussed above, if an appropriate molecular ratio of V₂O₃ and V₂O₅ is used, a substantially 50/50 ration of V(III) and V(IV) will result at step 514, resulting in balanced electrolyte solution 310.

In the embodiments shown in both FIGS. 5A and 5B, balanced electrolyte solution 310 can be adjusted to achieve a substantially 50/50 ration of V(III) and V(IV). Further, the balanced electrolyte solution 310 can be adjusted for a desired acidity and to add catalyst materials, for example bismuth salt or bismuth oxide, to the solution. Other catalysts can include lead, indium, tin, antimony or thallium, for example.

FIGS. 5C and 5D illustrate example processes for producing electrolyte solutions according to some embodiments of the present invention. As shown in FIG. 5C, V₂O₃ and V₂O₅ is measured out in the appropriate ratio. As described above, a molar concentration ratio of 1:2 to 1:6 of V₂O₅ and V₂O₃ can be used.

As shown in FIG. 5C, a solution of HCl can be added to a reactor. The reactor is large enough to hold the entire batch of the solution being mixed and can be equipped with a mechanical stirrer. The reactor may also include a thermal couple or other temperature monitoring device to monitor temperature of the solution during the reaction. The solution of HCl can be, for example, an aqueous solution of approximately 37% HCl to achieve a 4M HCl electrolyte solution.

In step 524, the V₂O₃ and V₂O₅ are then added to the mixture and, in step 526, the mechanical stirrer in the reactor is started to stir the mixture. The reaction will produce a temperature rise over a period of time, which will then decrease throughout the remainder of the reaction. For example, it is not uncommon for the solution to reach temperatures of about 50-90° C. during this portion of the reaction.

After a certain period of time, which may be as short as an hour, a sample of the solution is removed in step 528. The sample can be filtered and tested in step 530. The sample, for example, can be tested with a UV-vis spectrometer to determining the amount of dissolved vanadium in the solution, as well as the ratio of V(III) to V(IV). When the dissolved vanadium reaches an amount greater than about 97% of the theoretic amount, for example, the reaction is completed.

As shown in FIG. 5C, in step 532 a determination of whether the reaction is complete is made. The sample is tested and checked periodically, for example every hour, until the reaction is completed. In some embodiments, the reaction can be completed after 1-3 hours. When completed, in step 534 distilled water can be added into the mixture to achieve a particular concentration of both states of vanadium and acid and the solution is allowed to further cool. Additives such as a bismuth catalyst can also be added at this step.

In step 536, the solution is filtered. In some embodiments, a 1.0 to 4.0M vanadium solution with an acidity of 1 to 9 N HCl can be achieved with the process shown in FIG. 5C. Balancing the HCl solution with the amount of V₂O₃ and V₂O₅ along with the amount of distilled water added during the reaction can result in a wide range of vanadium concentrations and acidity concentrations in the final solution.

FIG. 5D illustrates another process for producing an electrolyte according to some embodiments of the present invention. As shown in FIG. 5D, in step 540 an appropriate ratio of V₂O₃ and V₂O₅ is measured into separate containers. As discussed above, the range of weight ratios can be as high as 1:6, or as low as 1:2.

In step 542, an amount of distilled water is acted to a reactor. The reactor is large enough to produce a batch of electrolyte and can be equipped with a mechanical stirrer, a heating element, and a thermal couple arranged to monitor the temperature of the solution. In step 544, a solution of HCl is added to the reactor. The amount of distilled water and the amount of HCl that is added is arranged to produce the amount of solution with the appropriate acidity and is matched with the amounts of V₂O₃ and V₂O₅ to arrive at the appropriate electrolyte (e.g. 2.0 M balanced VCl₃ and VOCl₂ and 4M HCl).

In step 546, about half of the V₂O₃ is added to the reactor. In step 548, the mechanical stirrer is started and in step 550 the solution is heated with the heating element to a particular temperature (e.g. 50 C), at which time the heating element is turned off.

In step 552, the V₂O₅ is added in multiple steps separated by a particular time. During this process, the temperature of the solution will rise, for example to 50-70° C. After a period of time from the addition of the last of the V₂O₃ in step 552, in step 554 the remainder of the V₂O₃ is added to the reactor. In step 556, the heating element is then used to raise and maintain the temperature of the solution, for example to 90° C., for a period of time (e.g., one hour). After step 556, a catalyst or other additive (e.g. bismuth) may be added to the solution and, in step 558, the solution is filtered.

In step 560, the solution may be analyzed. For example, the concentrations of V³⁺ and V⁴⁺ can be determined with UV-Vis spectroscopy and impurity levels can be measured by many methods, including inductively coupled plasma mass spectrometry (ICP-MS).

Particular temperatures and time periods provided in the above example processes can be any temperature higher than room temperature and time periods that allow the reaction in the reactor to complete. Completion of the reaction can be determined by testing or by duration of a sufficiently long time period.

Electrolyte production as described above produces electrolyte that exhibit high chemical stability. Using a sulfate-free solution, the vanadium ions are much more soluble, resulting in much higher energy densities that can be supported by the electrolyte during use in a flow cell batter. There results, in some embodiments, a high discharge voltage and an electrolyte that can support high current densities for fast charging and high power outputs from a flow cell battery. There is little to no side reactions, for example no H₂ or O₂ generation during production or use of the electrolyte according to some embodiments of the invention. The electrolyte is usable over a wide temperature window. The production of electrolyte according to some embodiments of the invention is very scalable and the resulting electrolyte can be produced in any quantities reliably and in a relatively cost-effective manner. The resulting electrolyte is reliable and stable.

Additionally, because of the electrolyte production according to some embodiments of the present invention as described above, the source of vanadium can include significant impurities, which will be filtered out of the solution in the filtering steps. Therefore, high quality vanadium free from impurities need not be used. As a result, the source of vanadium for use in the production of electrolyte according to some embodiments can be expanded to include secondary sources such as, for example, oil residues, power station fly ash, spent catalyst, V slags, or other secondary solution, substantially reducing the cost of producing the electrolyte.

Further, data has shown that the operating temperature window for some embodiments of the present invention is from −20° C. to 60° C., which provides a wide operating temperature range for the electrolyte. Further, the energy density of electrolyte produced according to some embodiments of the present invention can have twice the energy density that is illustrated in more conventional procedures and the performance of electrolyte according to some embodiments of the present invention can be significantly improved with addition of catalysts (e.g., bismuth) to the electrolyte. Further, electrolyte produced according to some embodiments of the present invention is significantly less viscous at operating temperatures than conventional vanadium electrolytes, resulting in less power loss, for example due to loss in pumps, than in conventional vanadium electrolytes.

Therefore, instead of the relatively low energy density due to low solubility of vanadium species in sulfuric acid, the limited operating temperature window of conventional electrolytes (10-35° C.), and the need for reconditioning or rebalancing due to undesirable side reactions commonly experienced in conventional electrolytes, some embodiments of electrolyte according to the present invention yield much better performance. Some embodiments of electrolyte according to the present invention support vanadium chloride in a sulfate-free, single acid HCl solution produced from low grade vanadium oxide. The vanadium is much more highly soluble in dilute HCl, resulting in has high as about 4 M vanadium solutions in hydrochloric acid to be produced. Electrolytes produced according to some embodiments operated over a wide temperature window, exhibit high energy densities, and show little to no side reactions. Further, electrolytes according to the present invention exhibit lower viscosity at operating temperatures than does conventional vanadium electrolytes, leading to less pump power loss.

### II. Formulation of the Electrolyte

Electrolyte produced by embodiments of the present invention can be all chloride (sulfate-free) or can include a concentration of sulfur compounds. Traditionally, sulfuric acid based vanadium electrolytes have been relatively low energy density due to the low solubility of Vⁿ⁺ species in sulfuric acid. These sulfuric acid based electrolytes have also had a limited operational temperature window (roughly 10-35° C.) due to the low solubility of Vⁿ⁺, especially at higher temperatures. Further, there is a need for reconditioning (or rebalancing) of the electrolyte used in flow-cell batteries due to undesirable side reactions during operation. A mixed acid electrolyte, VOSO₄ in hydrochloric acid, can result in higher solubility of Vⁿ⁺ species in the electrolyte, but still may need reconditioning during operation in the flow-cell battery due to undesired side reactions.

However, a sulfate-free vanadium electrolyte solves many of these issues. A sulfate-free vanadium electrolyte is formed using no sulfuric acid or vanadium sulfate additives to the electrolyte solution. In other words, the sulfate free vanadium electrolyte uses vanadium chloride in a single acid—hydrochloric acid—solution. For purposes of this disclosure, sulfate-free vanadium electrolyte is an electrolyte that is formed using only non-sulfur containing constituents, but may still have a minimal sulfur concentration due to trace impurity amounts in the materials used.

The raw materials that may be utilized in forming sulfate-free vanadium electrolyte according to some embodiments of the present invention can use lower grade vanadium oxide starting materials rather than high purity grade materials. The vanadium is highly soluble in HCl resulting in a much higher energy density and has a broad operational temperature window (in some cases −20 to 60° C., for example). The sulfate-free vanadium electrolyte is substantially less viscous than conventional vanadium electrolytes, which leads to less pump power losses. Further, with the addition of catalysts (for example Bismuth), many of the side reactions can be suppressed and performance is greatly enhanced.

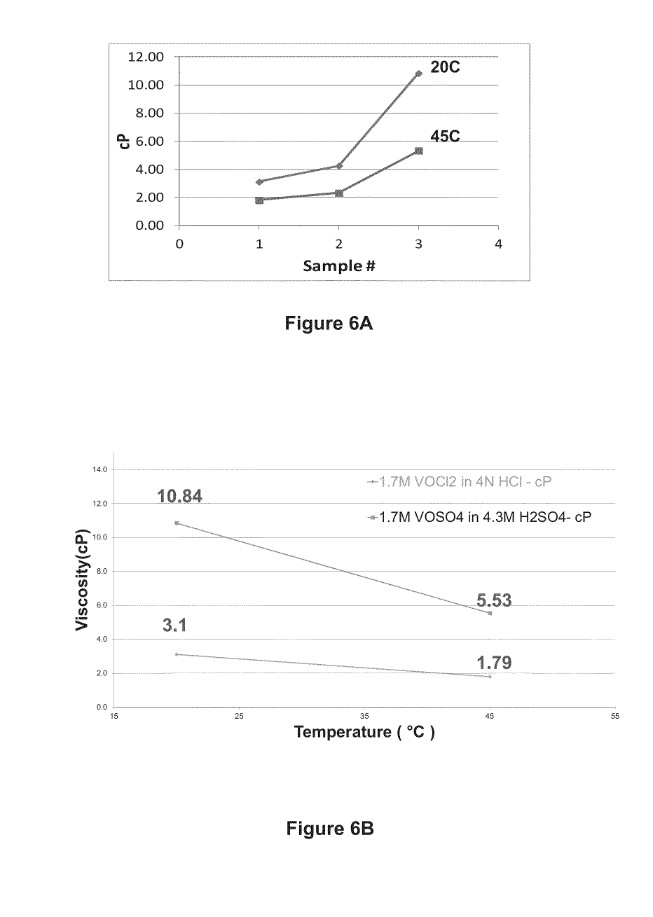

FIG. 6A illustrates viscosity of three samples at temperatures of 20° C. and 45° C. Sample 1 is 1.7M VOCl₂ in 4N HCl (a sulfate-free electrolyte). Sample 2 is 1.7 M VOSO₄ in 4N HCl. Sample 3 is 1.7M VOSO₄ in 4.3N H₂SO₄. Data was taken at temperatures of 20° C. and 45° C. That data is provided in the following table:

| | | | |
|---|---|---|---|
| Temp (C.) | Viscosity (cP) | Viscosity (cSt) | Density (g/ml) |

Sample 1 (1.7M VOCl₂/4N HCl)

| | | | |
|---|---|---|---|
| 20 | 3.1 | 2.51 | 1.235 |
| 45 | 1.79 | 1.47 | 1.217 |

Sample 2 (1.7M VOSO₄/4N HCl

| | | | |
|---|---|---|---|
| 20 | 4.24 | 3.27 | 1.296 |
| 45 | 2.31 | 1.80 | 1.284 |

Sample 3 (1.7M VOSO₄/4.3N H₂SO₄)

| | | | |
|---|---|---|---|
| 20 | 10.84 | 7.29 | 1.488 |
| 45 | 5.32 | 3.63 | 1.467 |

In the table, both the dynamic viscosity (in units of centipoise—cP) and kinematic viscosity (in units of centistokes-cSt). Also the density in g/ml is provided. As shown in FIG. 6, and in the above table, sample 1 is much less viscous at both 20° C. and 45° C. than samples 2 or sample 3. As is seen from the data, the viscosity of the sulfate-free electrolyte of sample 1 is lower in viscosity by about a factor of 3.5 from that of the electrolyte in sample 3 (all sulfate in sulfuric acid).

FIG. 6B illustrates graphically the viscocity as a function of temperature for 1.7M VOCl₂ in 4N HCl and for 1.7M VOSO₄ in 4.3M H₂SO₄. As is illustrated in FIG. 6B, viscosity for the sulfate-free electrolyte solution is a factor of 3-3.5 less across an operating range of temperatures from about 20° C. to about 45° C.

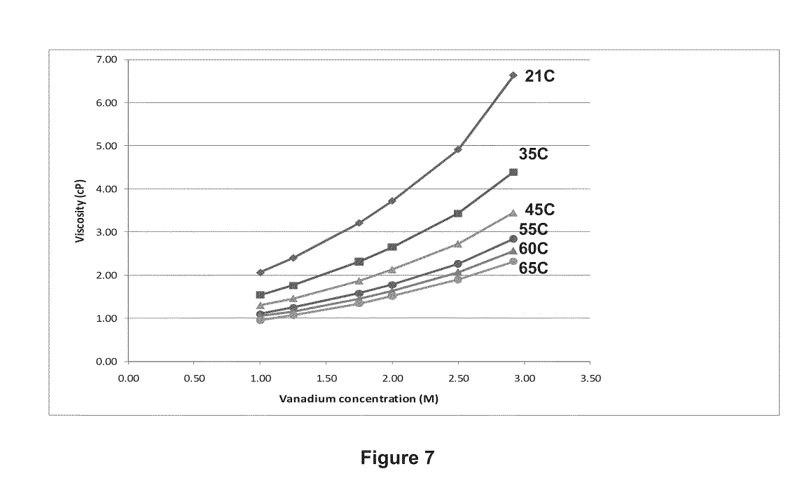

FIG. 7 illustrates the variation of viscosity with vanadium concentration in a sulfate-free electrolyte according to some embodiments of the present invention. As shown in FIG. 7, various electrolytes having a 1-3M VOCl₃ in 4N HCl composition are formed and viscosity measurements taken at temperatures of 21° C., 35° C., 45° C., 55° C., 60° C. and 65° C. As is shown in FIG. 7, viscosity increases with increased vanadium concentration. However, even high vanadium concentration electrolytes (3M) have a viscosity that is much lower than that of non sulfate-free electrolytes, as shown in FIG. 6.

In some embodiments, all chloride (sulfate-free) electrolyte have been prepared with 2.5 Molar VO²⁺ in 4 N HCl. The total acid molarity can be from 1 to 9 molar, for example 1-6 molar. The vanadium concentration can be between 0.5 and 4 M, for example 1.5 M, 2.5 M, or 3M. Higher concentration of vanadium have been prepared (e.g., 3.0 M vanadium in HCl) and utilized in a flow cell such as cell 100. Mixed electrolyte have also been prepared in HCl and sulfuric acid and utilized in a flow cell such as cell 100. All chloride (substantially no sulfate or sulfate-free electrolyte) is the most soluble and stable electrolytes at higher and lower temperatures, as sulfate anion reduces the solubility of vanadium species. All chloride solutions can be heated up 65° C. can be kept at 65° C. for a long time, where as sulfate based solutions precipitate at 40° C. Different ratios of sulfate and chloride can be prepared. The total acid molarity can be from 1 to 9 molar, for example 1-6 molar. The vanadium concentration can be between 0.5 to 4 M.

A catalyst can also be added to the electrolyte. In some embodiments, 5 ppm of Bi³⁺ for example Bismuth chloride or bismuth oxide can be added. This concentration can range from 1 ppm to 100 ppm. Other catalysts that can be utilized include lead, indium, tin, antimony, and thallium.

In one example preparation of solution 304, a 400 L reaction vessel equipped with a Teflon-coated mechanical stirrer and a Teflon-coated thermocouple was charged with DI water, glycerol and 37% HCl. V₂O₅ was added in installments over about two hours while the heterogeneous mixture was self-heated to 50-70° C. The progress of the reaction was monitored by absorption spectroscopy (UV-vis spectroscopy) at different time intervals. After a few hours of stirring the blue solution was filtered through five and one micron filters respectively. A Vanadium electrolyte of 1 to 4 M with acidity between 1 to 9N HCl can be produced by changing the amount of initial chemical that added into the reactor. From these example preparations of solution 304, preparation of electrolyte as illustrated in FIGS. 3A and 3B can be undertaken. The electrochemical process can be conducted at constant current mode.

In a second example, a sulfate-free, balanced vanadium electrolyte was produced according to the process illustrated in FIG. 5C. In step 520, V2O3 and V2O5 are weighed out, As discussed above, the V₂O₃ to V₂O₅ ratio could be, for example, between 6:1 to 2:1. The reactor can be a three neck round bottom flask large enough to hold the entire mix where the temperature is monitored by a Teflon coated thermal couple. In step 522, 37% HCl is added to the reactor. In step 528, samples are taken after one hour of reaction time. In step 534, after 3 hours of reaction time, distilled water was added. The resulting product was 1 to 4M vanadium with acidity of 1 to 9 N HCl.

In a third example, a sulfate-free vanadium electrolyte was produced according to the process illustrated in FIG. 5D. In step 540, V₂O₃ and V₂O₅ were weighed out in separate containers. The V₂O₃ to V₂O₅ ratio could be, for example, between 6:1 to 2:1. In step 542, distilled water was added. In step 544, 37% HCl was added. In step 550, the solution was heated to 50° C. In step 552, the V2O5 was added in a few parts at a few minute intervals. In step 554, the set time was a few minutes. In step 556, the temperature was raised to about 90° C. for one hour. The resulting solution was balanced (50% VCl3 and 50% VOCl2) electrolyte. The resulting product could be 1 to 4M vanadium with acidity could be 1 to 9 N HCl.

As discussed above, the processes for producing vanadium electrolyte according to embodiments of the present invention are scalable to any level of production.

### III. The Flow Cell System

The flow cell system 100 is generally described in the applications incorporated by reference herein. Although those systems are described in the context of a Fe/Cr chemistry, the flow cell system 100 operates equally well with the vanadium chemistry described herein. Tanks 122 and 124 can each be 200 liter tanks and the electrolyte formed according to the present invention as described above. Stack 126 includes 22 individual cells with a general reaction area of 2250 cm². Stack 126 can utilize Nippon 3 mm high density felt, Daramic membranes, impregnated Graphite foil bipolar plates, Ti current collectors. There is no rebalance cell and no catalyst plating procedure. A 150 A or higher charge can be utilized.

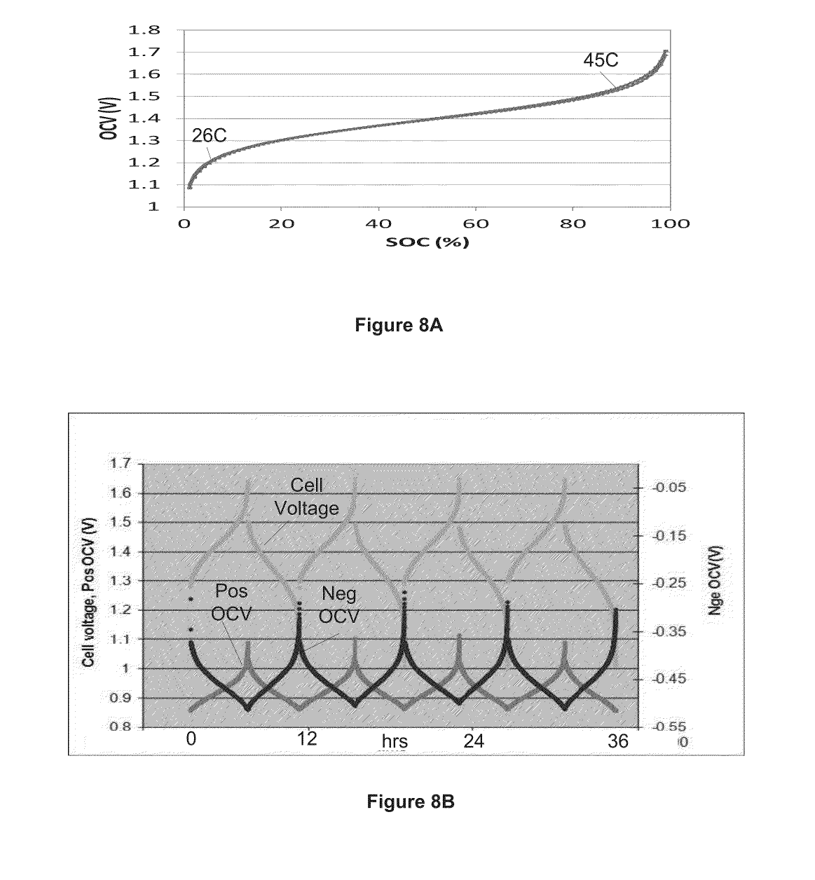

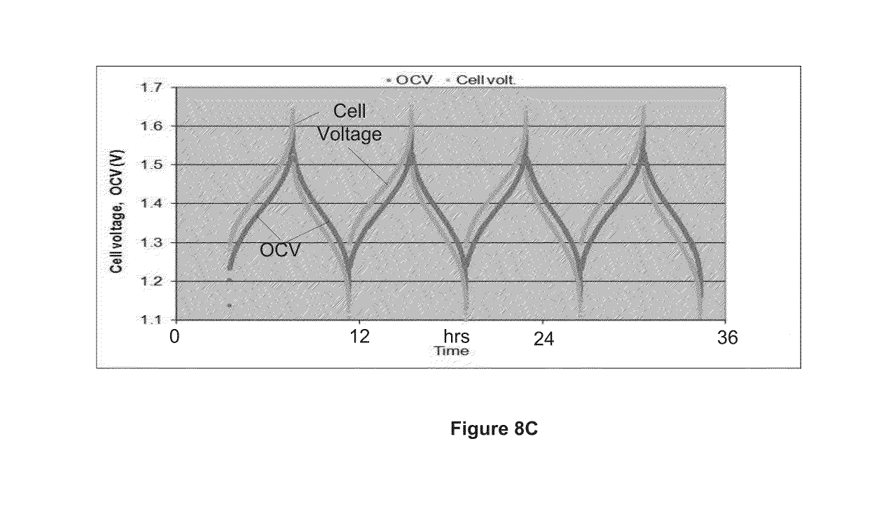

FIGS. 8A, 8B and 8C illustrate operation of sulfate-free vanadium electrolyte according to some embodiments of the present invention in a flow cell battery. FIG. 8A illustrates the open-circuit voltage (OCV) as a function of state-of-charge (SOC) for a 2M vanadium electrolyte at operating temperatures of 26° C. and 45° C. As is illustrated, there is little difference in performance over that temperature range. FIG. 8B illustrates the cell voltage, positive OCV, and Negative OCV over a period of 36 hrs for a flow-cell operating with a sulfate-free vanadium electrolyte according to some embodiments of the present invention. FIG. 8C illustrates the OCV and the cell voltage over time for a flow-cell operating with a sulfate-free vanadium electrolyte according to some embodiments of the present invention.

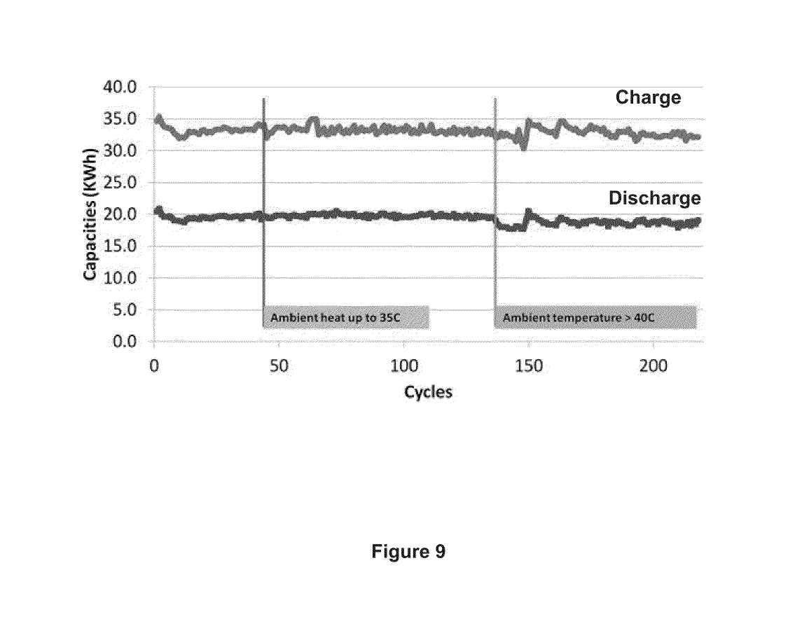

FIGS. 9 indicate a charge-discharge capacity cycling data for a 3 KW, 30 KWhr system which had 400 liter 2.5M vanadium single acid (4M HCl) electrolyte for both positive and negative side. The duration of the continuous testing was 6 month. The ambient temperature was heated to more than 40° C. intentionally to test the durability of the new electrolyte.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for providing an electrolyte solution, comprising:
forming a solution of a vanadium oxide and hydrochloric acid;
adjusting ionic species in the solution to form a mixture of V(III) and V(IV); and
adjusting the acidity of the solution to form the electrolyte solution.

2. The method of claim 1, wherein the solution of vanadium oxide includes V₂O₃ and adjusting the ionic species includes oxidizing the solution.

3. The method of claim 2, wherein the solution of vanadium oxide further includes V₂O₅ and adjusting the ionic species includes adjusting the relative concentrations of V₂O₅ and V₂O₃ added to the solution.

4. The method of claim 2, wherein the source of vanadium is from one or more of a group of secondary sources that includes oil residues, power station fly ash, spent catalyst and V slags.

5. The method of claim 2, wherein oxidizing the solution includes an air oxidation.

6. The method of claim 2, wherein oxidizing the solution includes bubbling oxygen through the solution.

7. The method of claim 1, wherein the solution is substantially sulfate free.

8. The method of claim 1, wherein the electrolyte solution includes a balanced solution of V³⁺ and V⁴⁺.

9. The method of claim 1, wherein adjusting the acidity of the solution results in a solution of approximately 2.5 M vanadium in about 4 M HCl.

10. The method of claim 1, wherein adjusting the acidity of the solution results in a solution of VO²⁺ in HCl, where VO²⁺ concentration can be 1 to 4 molar and acid concentration can be 1 to 9 molar.

11. The method of claim 1, further including addition of a catalyst to the acidic aqueous solution.

12. The method of claim 10, wherein the catalyst is about 1 ppm to about 100 ppm of Bismuth(III) salts.

13. The method of claim 10, wherein the catalyst is chosen from a group consisting of lead, indium, tin, antimony, bismuth and thallium.

14. A method of forming a sulfate-free vanadium electrolyte, comprising:
mixing V₂O₃ and V₂O₅ with hydrochloric acid in a reactor; and allowing a reaction to complete to form a solution with V(III) and V(IV) in hydrochloric acid; and
filtering the solution to provide the electrolyte.

15. The method of claim 14, wherein mixing V₂O₃ and V₂O₅ with hydrochloric acid in a reactor includes
measuring out an appropriate weight ratio of V₂O₃ and V₂O₅;
adding an HCL solution to a reactor;
adding the V₂O₃ and V₂O₅ to the reactor;

16. The method of claim 14, wherein allowing the reaction to complete includes stirring the solution in the reactor until a reaction in the reactor is complete.

17. The method of claim 14, further including adding water to the solution in the reactor.

18. The method of claim 16, further including removing a sample from the reactor for testing periodically to determine whether the reaction is complete.

19. The method of claim 16, further including waiting a period of time for the reaction in the reactor to complete.

20. The method of claim 15, wherein measuring out an appropriate weight ratio of V₂O₃ and V₂O₅ includes measuring a ratio of between 2:1 and 6:1 of V₂O₃ to V₂O₅.

21. The method of claim 14, wherein mixing V₂O₃ and V₂O₅ with hydrochloric acid in a reactor includes
measuring out an appropriate weight ratio of V₂O₃ and V₂O₅ into separate containers;
adding distilled water and hydrochloric acid to a reactor;
adding about half the measured quantity of V₂O₃ to the reactor;
stirring the solution
heating to a set temperature;
adding the V₂O₅ in multiple parts separated by a period of time; and
adding the remainder of the V₂O₃ to the reactor after a wait time.

22. The method of claim 14, wherein allowing a reaction to complete includes heating the solution to a second temperature for a reaction time.

23. The method of claim 21, wherein measuring out an appropriate weight ratio of V₂O₃ and V₂O₅ includes measuring a ratio of between 2:1 and 6:1 of V₂O₃ to V₂O₅.

24. An electrolyte, comprising a sulfate-free solution of V³⁺ and V⁴⁺ in a hydrochloric acid solution.

25. The electrolyte of claim 24, further including a catalyst.

26. The electrolyte of claim 24, wherein an operating temperature range of the electrolyte is between −20° C. and 60° C.

27. The electrolyte of claim 23, wherein a viscosity of the electrolyte is less than 3.1 over a range of 20° C. to 45° C.

28. The electrolyte of claim 23, with vanadium concentration of at least 2.5M.
